(19) United States
(12) Patent Application Publication
(10) Pub. No.: US 2026/0321735 A1
(43) Pub. Date: Oct. 15, 2026

(54) SECONDARY BATTERY

(71) Applicant: SAMSUNG SDI CO., LTD., Yongin-si (KR)

(72) Inventors: Ho Sik SHIN, Yongin-si (KR); Sang Hyup MOON, Yongin-si (KR)

(21) Appl. No.: 19/311,101

(22) Filed: Aug. 27, 2025

(30) Foreign Application Priority Data
Apr. 11, 2025 (KR) 10-2025-0047267

(51) Int. Cl. H01M 10/0587; B60L 50/64; H01M 4/70; H01M 10/052; H01M 50/586; H01M 50/595

(52) U.S. Cl. CPC H01M 10/0587; B60L 50/64; H01M 4/70; H01M 10/052; H01M 50/586; H01M 50/595; H01M 2220/20

(57) ABSTRACT

A secondary battery includes an electrode assembly having a first electrode plate, a second electrode plate, and a separator between the first and second electrode plates, with the electrode assembly being a jelly-roll type structure. The first electrode plate includes a conductive substrate including a first electrode plate-first side and a first electrode plate-second side opposite to the first electrode plate-first side, an inner circumferential tab welded to the first electrode plate-first side, a first electrode plate-first protective tape attached to the first electrode plate-first side while wrapping around the inner circumferential tab, and a first electrode plate-second protective tape attached to the first electrode plate-second side and corresponding to the first inner circumferential tab.

### CROSS-REFERENCE TO RELATED APPLICATION

The present application claims priority to and the benefit of Korean Patent Application No. 10-2025-0047267, filed on Apr. 11, 2025, in the Korean Intellectual Property Office, the entire disclosure of which is incorporated herein by reference.

### BACKGROUND

### 1. Field

Aspects of some embodiments of the present disclosure relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

The present disclosure provides a secondary battery with an improved peak power dispersion occurring during an ultrasonic welding process. The present disclosure also provides a secondary battery that suppresses a backing agent transfer phenomenon by changing a tape attachment method and material and improves the peak power distribution during ultrasonic welding. In an example, provided is a secondary battery in which a backing agent transfer phenomenon is prevented by not using a heating-adhesion method and instead using a room-temperature-adhesion method, thereby reducing peak power dispersion that occurs during ultrasonic welding. In addition, the present disclosure provides a secondary battery in which elongation is increased and a curl phenomenon of an electrode plate is ameliorated by eliminating a hot-melt adhesive and using a low-adhesion tape based on an acrylate adhesive.

These and other aspects and features of the present disclosure will be described in or will be apparent from the following description of embodiments of the present disclosure.

A secondary battery according to some embodiments of the present disclosure may include an electrode assembly having a first electrode plate, a second electrode plate, and a separator between the first and second electrode plates, with the electrode assembly being wound in a jelly-roll type, wherein the first electrode plate comprises: a conductive substrate including a first electrode plate-first side and a first electrode plate-second side opposite to the first electrode plate-first side; an inner circumferential tab welded to the first electrode plate-first side; a first electrode plate-first protective tape attached to the first electrode plate-first side while wrapping around the inner circumferential tab; and a first electrode plate-second protective tape attached to the first electrode plate-second side and corresponding to the inner circumferential tab.

According to some embodiments, the conductive substrate of the first electrode plate may include: a flat first electrode plate-first region located in a winding core region, with the first inner circumferential tab being welded to the first electrode plate-first side in the first electrode plate first region; a first electrode plate-bent region that is bent into a “U” shape and extends from the first electrode plate-first region; and a flat first electrode plate-second region that extends from the first electrode plate-bent region and is opposite to the first electrode plate-first region.

According to some embodiments, the first electrode plate-first protective tape may be attached to the first electrode plate-first side in the first electrode plate-first region, the first electrode plate-bent region, and the first electrode plate-second region, and the first electrode plate-second protective tape may be attached to the first electrode plate-second side in the first electrode plate-first region, the first electrode plate-bent region, and the first electrode plate-second region of the first electrode plate-second side.

According to some embodiments, the first inner circumferential tab may overlap the first electrode plate-second protective tape in the thickness direction of the electrode assembly.

According to some embodiments, the first electrode plate may further include an active material layer coated on at least one of the first electrode plate-first side and the first electrode plate-second side of the first conductive substrate, and wherein uncoated portions where the active material layer is not provided are formed on the first electrode plate-first side and the first electrode plate-second side in the first electrode plate-first region, the first electrode plate-bent region, and the first electrode plate-second region.

According to some embodiments, at least one of the first electrode plate-first protective tape and second electrode plate-second protective tapes may be a room-temperature-adhesion-method low-adhesive tape including a backing agent, a polyethylene terephthalate (PET) layer, and an acrylate adhesive that does not include a hot-melt adhesive.

According to some embodiments, the first electrode plate-second protective tape may be a room-temperature-adhesion-method low-adhesive tape including a backing agent, a PET layer, and an acrylate adhesive that does not include a hot-melt adhesive.

According to some embodiments, the first electrode plate-first protective tape may be a heat-adhesion-method heat-compression tape including a backing agent, a polyethylene terephthalate layer, and an adhesive including acrylate and a hot melt adhesive, and the first electrode plate-second protective tape may be a room-temperature-adhesion-method low-adhesive tape including a backing agent, a polyethylene terephthalate layer, and an acrylate adhesive that does not include a hot-melt adhesive.

According to some embodiments, at least one of the first electrode plate-first protective tape and first electrode plate-second protective tape is a room-temperature-adhesion-method low-adhesive tape from which a backing agent is not transferred in the electrode assembly.

According to some embodiments, the first electrode plate-second protective tape may be a room-temperature-adhesion-method low-adhesive tape from which a backing agent is not transferred to a portion of the first electrode plate to which the inner circumferential tab is to be welded.

According to some embodiments, the second electrode plate may include: a second conductive substrate including a second electrode plate-first side and a second electrode plate-second side opposite to the second electrode plate-first side; a second inner circumferential tab welded to the second electrode plate-second side; a second electrode plate-first protective tape attached to the second electrode plate-second side and wrapping around the second inner circumferential tab; and a second electrode plate-second protective tape attached to the second electrode plate-first side and corresponding to the second inner circumferential tab.

According to some embodiments, second conductive substrate may include: a flat second electrode plate-first region located in the winding core region, with the second inner circumferential tab being welded to the second electrode plate-second side in the second electrode plate-first region; a second electrode plate-bent region that is bent into a “U” shape and extends from the second electrode plate-first region; and a flat second electrode plate-second region that extends from second electrode plate-bent region and is opposite to the second electrode plate-first region.

According to some embodiments, the second electrode plate-first protective tape may be attached to the second electrode plate-second side in the second electrode plate-first region.

According to some embodiments, the second inner circumferential tab may overlap the second electrode plate-second protective tape in the thickness direction of the electrode assembly.

According to some embodiments, the second electrode plate may further include a second active material layer coated on at least one of the second electrode plate-first side and the second electrode plate-second side of the second conductive substrate, and wherein uncoated portions where the active material layer is not provided are formed on the second electrode plate-first side and second electrode plate-second side in the second electrode plate-first region, the second electrode plate-bent region, and the second electrode plate-second region.

According to some embodiments, at least one of the second electrode plate-first protective plate and second electrode plate-second protective tape may be a room-temperature-adhesion-method low-adhesive tape including a backing agent, a polyethylene terephthalate (PET) layer, and an acrylate adhesive that does not include a hot-melt adhesive.

According to some embodiments, the second electrode plate-second protective tape may be a room-temperature-adhesion-method low-adhesive tape including a backing agent, a polyethylene terephthalate layer, and an acrylate adhesive that does not include a hot-melt adhesive

According to some embodiments, the second electrode plate-first protective tape may be a heat-adhesion-method heat-compression tape including a backing agent, a polyethylene terephthalate (PET) layer, and an adhesive including acrylate and a hot melt adhesive, and the second electrode plate-second protective tape may be a room-temperature-adhesion-method low-adhesive tape including a backing agent, a polyethylene terephthalate (PET) layer, and an acrylate adhesive that does not include a hot-melt adhesive.

According to some embodiments, at least one of the second electrode plate-first protective tape and second electrode plate-second protective tapes may be a room-temperature-adhesion-method low-adhesive tape in which a backing agent is not transferred in the electrode assembly

According to some embodiments, the second electrode plate-second protective tape may be a room-temperature-adhesion-method low-adhesive tape from which a backing agent is not transferred to regions of the second electrode plate-second side to which the second inner circumferential tab is to be welded.

However, aspects and features of the present disclosure are not limited to those described above, and other aspects and features not mentioned will be clearly understood by a person skilled in the art from the detailed description, described above.

The present disclosure can improve a peak power distribution that occurs during ultrasonic welding. By changing a tape attachment method and material, a contact failure due to transfer of a backing agent can be eliminated, and, as a result, the peak power distribution occurring during the ultrasonic welding process can be reduced. This improves the welding quality, and in particular, facilitates the welding quality by enabling distinction between genuine and false failures.

Further, by adopting a room-temperature-adhesion-method tape, the transfer of the backing agent can be suppressed, and a contact failure problem that may occur can be prevented. This increases the accuracy and reliability of ultrasonic welding and reduces a failure rate. This improvement contributes to increasing manufacturability, reduced downtime losses during the process, and improves the efficiency of the entire manufacturing process.

In addition, the elongation of the tape increases, improving a curling phenomenon of an electrode plate, which makes ultrasonic welding more stable, and simultaneously secures the quality and stability of the electrode plate.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic diagram showing a process of ultrasonically welding a tab to an electrode plate unwound from an electrode plate reel during a manufacturing process of an electrode assembly.

FIGS. 2 and 3 are a perspective view and an exploded perspective view showing a pouch type battery according to an embodiment of the present disclosure.

FIG. 4 is a cross-sectional view showing an electrode assembly in the pouch type battery according to an embodiment of the present disclosure.

FIG. 5 is an enlarged view of a partial region of FIG. 4.

FIG. 6 is an enlarged cross-sectional view showing a structure of a protective tape in the electrode assembly according to an embodiment of the present disclosure.

FIGS. 7 and 8 are perspective views showing a battery pack including the secondary battery according to some embodiments.

FIGS. 9 and 10 are perspective and side views showing a vehicle including aspects of an example battery pack according to some embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein.

Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be arranged in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components “.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

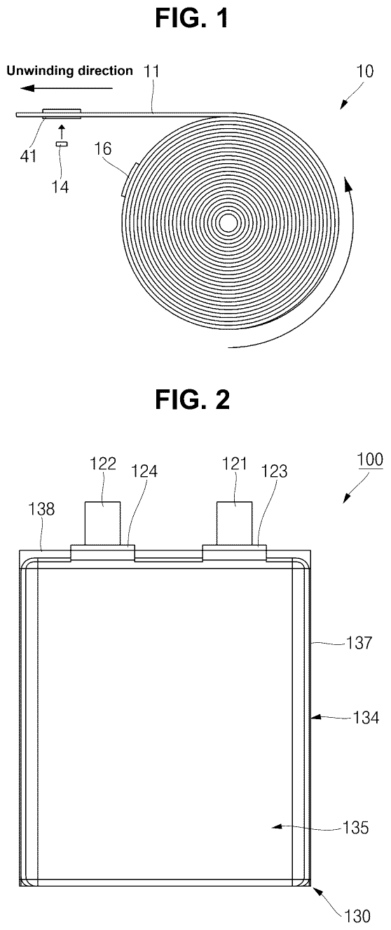

FIG. 1 schematically shows a process of ultrasonically welding a tab 14 to an electrode plate 11 unwound from an electrode plate reel 10 during a manufacturing process of an electrode assembly.

As shown in FIG. 1, when the electrode plate reel 10 is provided in an ultrasonic tab welding process, some regions of the electrode plate 11 have already been covered with the protective tape 16 in a previous process. That is, the protective tape 16 is bonded to some regions of the electrode plate 11 by a heat compression method and then wound onto the electrode plate reel 10. Due to this bonding method and structure, when the electrode plate 11 is unwound from the electrode plate reel 10, a backing material 41 (e.g., wax) of the protective tape 16 may remain in a tab welding region. This backing material 41 may cause a welding failure to occur between a tab and an electrode plate in an ultrasonic welding process. This problem is mainly identified through the welding power measured by welding equipment. In particular, the peak distribution of the welding power is large in the overlapping area of a tab welding area and a protective tape, which deteriorates the welding quality of the tab and makes it difficult to identify failure products. As a result, problems such as reduced manufacturing efficiency and increased downtime may occur.

To solve these problems, the present disclosure provides techniques for suppressing a backing agent transfer phenomenon by improving a tape attachment method and material and by effectively reducing a peak power distribution during ultrasonic welding.

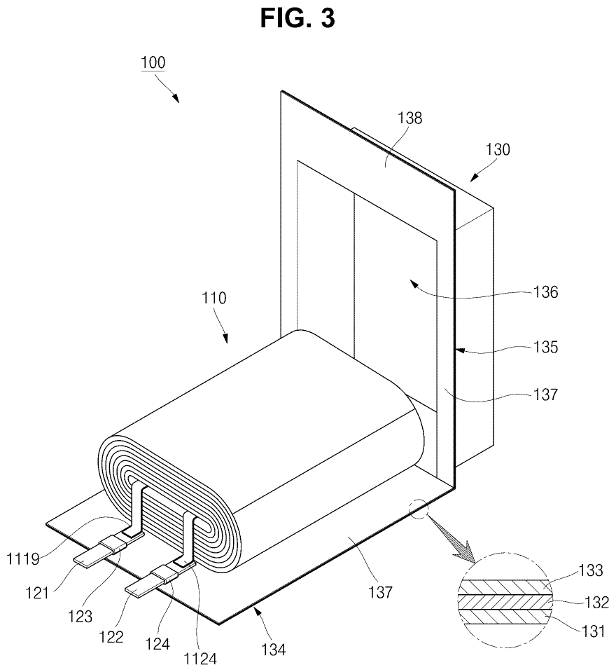

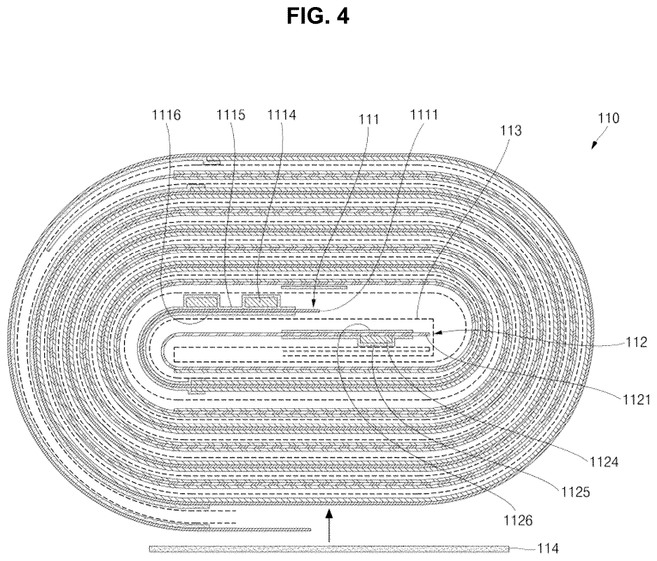

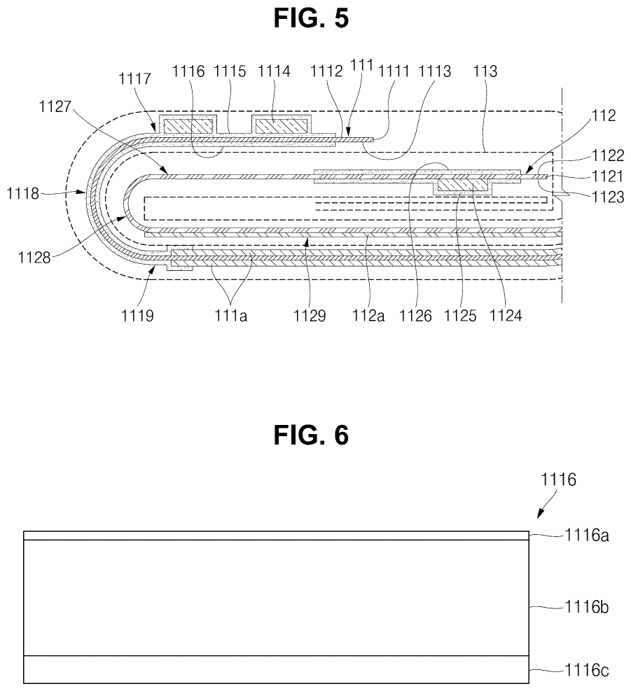

FIGS. 2 and 3 are a perspective view and an exploded perspective view showing a pouch type battery 100 according to an embodiment of the present disclosure, FIG. 4 is a cross-sectional view showing an electrode assembly 110 in the pouch type battery 100 according to an embodiment of the present disclosure, and FIG. 5 is an enlarged view of a partial region of FIG. 4. FIG. 6 is an enlarged cross-sectional view showing the structure of a protective tape 116 in the electrode assembly according to an embodiment of the present disclosure.

As shown in FIGS. 2 to 6, the pouch type battery 100 according to an embodiment of the present disclosure may include an electrode assembly 110 and a case 130. The battery 100 may also include a first electrode tab 121 and a second electrode tab 122 for electrical connection to an external device.

The electrode assembly 110 may include a first electrode plate 111, a second electrode plate 112, and a separator 113 interposed between the first and second electrode plates 111 and 112, all of which may be wound in a jellyroll shape. When the first electrode plate 111 operates as a positive electrode, the second electrode plate 112 may operate as a negative electrode. When the first electrode plate 111 operates as a negative electrode, the second electrode plate 112 may operate as a positive electrode. The electrode assembly 110 may include or be referred to as an electrode group, an electrode body, or a jelly roll.

In one or more embodiments, the first electrode plate 111 may include a first conductive substrate 1111, a first inner circumferential tab 1114, a first electrode plate-first protective tape 1115, and a first electrode plate-second protective tape 1116.

The first conductive substrate 1111 may include a first electrode plate-first side 1112 and a first electrode plate-second side 1113 opposite thereto. The first inner circumferential tab 1114 may be ultrasonically welded to the first electrode plate-first side 1112. The first conductive substrate 1111 may include or be referred to as a current collector or a current collector plate. The first inner circumferential tab 1114 may include or be referred to as a strip terminal or a lead tab and may be made of a material similar to or identical to the first conductive substrate 1111. According to some embodiments, two or more of the first inner circumferential tabs 1114 may be provided so as to be spaced apart from each other. The first electrode plate-first protective tape 1115 may be attached to the first electrode plate-first side 1112 while wrapping around the first inner circumferential tab 1114. The first electrode plate-second protective tape 1116 may be attached to the first electrode plate-second side 1113 corresponding to the first inner circumferential tab 1114. The protective tape may include or be referred to as a lamination tape or an insulation tape.

With this configuration, the electrical conductivity and stability of the first electrode plate 111 can be improved, and problems that may occur during ultrasonic welding can be solved. The first conductive substrate 1111 can provide the conductivity for the first electrode plate 111, and the first inner circumferential tab 1114 can support electrical connection. In addition, the first electrode plate-first protective tape 1115 and the first electrode plate-second protective tape 1116 can prevent transfer of a backing agent to a welding area, thereby reducing a peak power distribution and improving welding quality. As a result, the consistency in quality of an electrode plate can be maintained, the failure rate can be reduced, and the manufacturing process can be optimized.

The morphological features of the first electrode plate 111 may be configured such that each of the first electrode plate-first side 1112 and the first electrode plate-second side 1113 includes a first electrode plate-first region 1117, a first electrode plate-bent region 1118, and a first electrode plate-second region 1119.

The first electrode plate-first region 1117 may be located at a winding core part (i.e., a region where winding of the electrode assembly begins) and may be flat. The first inner circumferential tab 1114 may be ultrasonically welded to the first electrode plate-first side 1112 in the first electrode plate-first region 1117. The first electrode plate-bent region 1118 may be bent into a “U” shape from the first electrode plate-first region 1117. The first electrode plate-second region 1119 may extend from the bent region to form a flat portion facing the first electrode plate-first region 1117.

The first electrode plate-first protective tape 1115 may be attached to the first electrode plate-first region 1117, the first electrode plate-bent region 1118, and the first electrode plate-second region 1119, which together form the first electrode plate-first side 1112. The first electrode plate-second protective tape 1116 may be attached to the first electrode plate-first region 1117, the first electrode plate-bent region 1118, and the first electrode plate-second region 1119, which together form the first electrode plate-second side 1113. In addition, a portion of the first inner circumferential tab 1114 may overlap a portion of the first electrode plate-second protective tape 1116 in the thickness direction.

With this configuration, the morphological features of the first electrode plate 111 can be improved and the welding quality can be improved. The flat first electrode plate-first region 1117 allows the welded first inner circumferential tab 1114 to be stably positioned and also maintains the welding quality between the ultrasonically welded first inner circumferential tab 1114 and the first conductive substrate 1111. The U-shaped first electrode plate-bent region 1118 improves the mechanical strength of the electrode plate, and the flat first electrode plate-second region 1119 extends from the bent region such that the structural stability and efficiency of the electrode plate can be improved. Further, the first region 1117, the bent region 1118, and the second region 1119 are wrapped with the first and second protective tapes 1115 and 1116 to thereby improve the structural stability of the corresponding regions.

The first electrode plate 111 may further include a first active material layer 111a (e.g., a positive electrode active material layer), and the first active material layer 111a may be coated on at least one of the first electrode plate-first side 1112 and first electrode plate-second side 1113. The first electrode plate-first region 1117, the first electrode plate-bent region 1118, and the first electrode plate-second region 1119 of the first and second sides 1112 and 1113 of the first electrode plate may include an uncoated portion where the first active material layer 111a is not provided. The first active material layer 111a may occupy most of the first electrode plate-second region 1119.

The first electrode plate-first protective tape 1115 may be a room-temperature-adhesion-method low-adhesive tape including a backing agent 1116a, a polyethylene terephthalate (PET) layer (1116b), and an acrylate adhesive 1116c that does not include a hot melt adhesive. In addition, the first electrode plate-second protective tape 1116 may be a room-temperature-adhesion-method low-adhesive tape including a backing agent 1116a, a PET layer 1116b, and an acrylate adhesive 1116c that does not include a hot melt adhesive. In other embodiments, the first electrode plate-first protective tape 1115 may be a heat-adhesion-method heat-compression tape including a backing agent 1116a, a PET layer 1116b, and an adhesive 1116c including acrylate and hot melt adhesive, and the first electrode plate-second protective tape 1116 may be a room-temperature-adhesion-method low-adhesive tape including a backing agent 1116a, a PET layer 1116b, and an acrylate adhesive 1116c that does not include a hot melt adhesive. As the first electrode plate-first protective tape 1115 is attached after ultrasonic welding of the first inner circumferential tab 1114, and the first electrode plate-first protective tape 1115 may be a heat-adhesion-method heat-compression tape including hot melt, as is conventional.

The first electrode plate-second protective tape 1116 may be configured to prevent the backing agent 1116a from being transferred during the manufacturing process of the electrode assembly 110. In particular, the first electrode plate-second protective tape 11 may be configured to prevent the backing agent 1116a from being transferred to regions of the first side 1112 to which the first inner circumferential tab 1114 is to be welded. Accordingly, a peak power distribution problem that may occur during ultrasonic welding of the first inner circumferential tab 1114 can be ameliorated and the failure rate may be lowered. In practice, the protective tape corresponding to an ultrasonic tab welding area of the first conductive substrate 1111 is attached to an electrode plate that is manufactured.

The second electrode plate 112 may include a similar configuration and operation to the first electrode plate 111. Specifically, the second electrode plate 112 may include a second conductive substrate 1121, a second inner circumferential tab 1124, a second electrode plate-first protective tape 1125, and a second electrode plate-second protective tape 1126.

The second conductive substrate 1121 may include a second electrode plate-first side 1122 and a second electrode plate-second side 1123 opposite to the second electrode plate-first side 1122. The second inner circumferential tab 1124 may be ultrasonically welded to the second electrode plate-second side 1123. The second inner circumferential tab 1124 may also be provided as at least two second inner circumferential tabs that are spaced apart from each other. The second electrode plate-first protective tape 1125 may be attached to the second electrode plate-second side 1123 while wrapping around the second inner circumferential tab 1124. The second electrode plate-second protective tape 1126 may be attached to a partial region of the second electrode plate-first side 1122 corresponding to the second inner circumferential tab 1124.

The morphological features of the second electrode plate 112 may be configured such that each of the second electrode plate-first side 1122 and the second electrode plate-second side 1123 includes a second electrode plate-first region 1127, a second electrode plate-bent region 1128, and a second electrode plate-second region 1129

The second electrode plate-first region 1127 may be located at a winding core part winding core part and may be flat. The second inner circumferential tab 1124 may be ultrasonically welded to the second electrode plate-first region 1127 of the second electrode plate-second side 1123. The second electrode plate-bent region 1128 may be bent into a “U” shape from the second electrode plate-first region 1127. The flat second electrode plate-second region 1129 may extend from the second electrode plate-bent region 1128 and may face the second electrode plate-first region 1127. The second electrode plate-first protective tape 1125 may be attached to the second electrode plate-first region 1127 of the second electrode plate-second side 1123. The second electrode plate-second protective tape 1126 may be attached to the second electrode plate-first region 1127 of the second electrode plate-first side 1122. At least a portion of the second inner circumferential tab 1124 may overlap a portion of the second electrode plate-second protective tape 1126 in the thickness direction.

The second electrode plate 112 may further include a second active material layer 112a coated on at least one of the second electrode plate-first side 1122 and second electrode plate-second side 1123 of the second conductive substrate 1121. The second electrode plate-first region 1127, second electrode plate-bent region 1128 and second electrode plate-second region 1129 of the second electrode plate-first and second sides 1123 and 1124 may include uncoated portions where the second active material layer 112a is not provided.

At least one of the second electrode plate-first and second protective tapes 1124 and 1126 may be a room-temperature-adhesion-method low-adhesive tape including a backing agent 1116a, a PET layer 1116b, and an acrylate adhesive 1116c that does not include a hot melt adhesive. The second electrode plate-second protective tape 1126 may be a room-temperature-adhesion-method low-adhesive tape including a backing agent 1116a, a PET layer 1116b, and an acrylate adhesive 1116c that does not include a hot melt adhesive. The second electrode plate-first protective tape 1125 may be a heat-adhesion-method heat-compression tape including a backing agent 1116a, a PET layer 1116b, and an adhesive 1116c including acrylate and a hot melt adhesive, and the second electrode plate-second protective tape 1126 may be a room-temperature-adhesion-method low-adhesive tape including a backing agent 1116a, a PET layer 1116b, and an acrylate adhesive 11160 that does not include a hot-melt adhesive. As the second electrode plate-first protective tape 1125 is attached after ultrasonic welding of the second inner circumferential tab 1124, and the second electrode plate-first protective tape may be a heat-adhesion-method heat-compression tape including hot melt adhesive.

The second electrode plate-second protective tape 1126 may be configured to prevent the backing agent 1116a from being transferred during the process of manufacturing the electrode assembly 110, and, in particular, prevent the backing agent 1116a from being transferred to regions of the second side 1123 where the second inner circumferential tab 1124 is to be welded. Accordingly, a peak power distribution problem that may occur during ultrasonic welding can be ameliorated, and the failure rate may be lowered. In practice, it should be noted that a protective tape in which a backing agent can be transferred to an ultrasonic tab welding area of the second conductive substrate 1121 is a protective tape attached to an electrode plate to be manufactured next. In other words, the protective tape corresponding to an ultrasonic tab welding area of the second conductive substrate 1121 is attached to an electrode plate that is manufactured.

Table 1 below shows comparison of various characteristics of the a heat-compression tape and the low-adhesive tape according to the present disclosure. Here, room temperature means a temperature in the range of approximately 10-60° C.

TABLE 1

| | | Unit | Heat-compression tape | Low-adhesive tape |
|---|---|---|---|---|
| Thickness/width | | μm/mm | 15/10.0 | 15/10.0 |
| Material | | | Backing agent (less | Backing agent (less |
| | | | than 1 μm)/upper PET | than 1 μm)/upper PET |
| | | | layer (12 μm)/lower | layer(12 μm)/lower |
| | | | adhesion layer (3 μm) | adhesion layer (3 μm) |
| Adhesion method | | | Heat compression | Room-temperature |
| | | | adhesion | compression adhesion |
| Adhesive | | | Acrylate + hot melt | Acrylate + additive |
| | | | adhesive + additive | |
| Physical | Elongation | % | 87 | 106 |
| property | Tensile strength | kgf/cm² | 2056 | 1865 |
| | Room-temperature | gf/25 mm | 110 (450@60° C.) | 260 |
| | adhesive force | | | |

Among the components of the adhesive, additives may improve the properties of the adhesive. Such additives may include cross-linking agents and/or curing agents, and the types and contents thereof may vary depending on specific application purposes or technical requirements.

The present disclosure reduces a peak power distribution that occurs during ultrasonic welding, thereby improving welding quality and enabling distinction between genuine and false failures. By changing the attachment method and material of a protective tape, a contact failure due to transfer of a backing agent can be prevented. By adopting a room-temperature bonding method, a contact failure problem can be prevented in advance. As a result, a failure rate can be reduced, and manufacturability and process efficiency can be improved. In addition, a curling phenomenon of an electrode plate can be improved by increasing the elongation, so that ultrasonic welding can be performed more stably.

The above-described first inner circumferential tab 1114 may be welded to the first electrode tab 121 by ultrasonic or laser welding. And the second inner circumferential tab 1124 may be welded to the second electrode tab 122 by ultrasonic or laser welding.

Although the present disclosure has been described with reference to the electrode assembly 110 having first and second inner circumferential tabs that are ultrasonically welded on the inner side, the present disclosure can be equally or similarly applied to an electrode assembly having first and second outer circumferential tabs that are ultrasonically welded on the outer side. In addition, at least one negative electrode inner circumferential tab may be welded to the inner side of the electrode assembly 110, and at least one negative electrode outer circumferential tab may be welded to the outer side of the electrode assembly 110. Further, at least one positive electrode inner circumferential tab may be welded to the inner side of the electrode assembly 110, and at least one positive electrode outer circumferential tab may be welded to the outer side of the electrode assembly 110.

The separator 113 may be interposed between the first electrode plate 111 and the second electrode plate 112. According to some embodiments, the separator 113 may surround the first electrode plate 111 or the second electrode plate 112. The separator 113 may include polyethylene, polypropylene, and porous copolymers of polyethylene and polypropylene. The separator 113 may also be provided with a ceramic coating on the surface thereof to improve thermal performance. The width of the separator 113 may be larger than the widths of the first electrode plate 111 and the second electrode plate 112 to prevent electrical short circuits between the first electrode plate 111 and the second electrode plate 112.

It should also be noted that the outermost part of the electrode assembly 110 is finished with a finishing tape 114, so that the electrode assembly 110 may not become loosely assembled.

The case 130 may be provided to accommodate the electrode assembly 110 and seal the outer periphery of the electrode assembly 110. The case 130 may include or be referred to as an outer material, a pouch, a can, or a housing. The case 130 may be provided as a laminate structure having, for example, a first insulating layer 131, a metal layer 132, and a second insulating layer 133. Various adhesive layers or functional layers may be further added.

The case 130 may include a first case 134 and a second case 135 having one end connected to the first case 134 and having a recess 136 of a predetermined depth to accommodate the electrode assembly 110. The peripheries of the first and second cases 134 and 135 corresponding to the outer periphery of the electrode assembly 110 are heat-welded to each other such that the electrode assembly 110 can be accommodated inside the case 130, which is roughly of a pouch or pocket type. The case 130 may be provided by forming the first case 134 and the second case 135 by folding the middle of the case 130, which is an integrally formed square plate-shaped case, on the basis of the length direction of one side of the case 130. A recess 136 of a certain depth, in which the electrode assembly 110 can be accommodated, can be formed in the second case 135 by a press or drawing process, and a sealing region 137 for sealing with the first case 134 may be provided on the outer periphery of the recess 136. The sealing region 137 may be provided along one side where the first case 134 and the second case 135 are integrally in contact and the remaining three sides.

The case 130 may be formed from stainless steel. In such embodiments, laser welding can be used to seal the stainless steel.

As described above, the first inner circumferential tab 1114 of the electrode assembly 110 may be welded to the first electrode tab 121, and the second substrate tab 1124 may be welded to the second electrode tab 122. According to some embodiments, the first electrode tab 121 and the second electrode tab 122 may extend outwardly from the case 130 to a predetermined length via a first sealing tape 123 and a second sealing tape 124, respectively. A region of the case 130 where the first electrode tab 121 and the second electrode tab 122 extend outwardly may be referred to as a terrace 138. The first electrode tab 121 may be made of aluminum, and the second electrode tab 122 may be made of copper and nickel.

The present disclosure can provide a configuration that solves the peak power distribution problem that occurs during ultrasonic welding and reduces the failure rate. For example, in the present disclosure the structures of a protective tape and an inner circumferential tab of an electrode plate are improved to reduce a peak power distribution that may occur during ultrasonic welding. In particular, the protective tape can reduce the failure rate during welding and improve quality by preventing the backing agent from being transferred.

In addition, in the present disclosure the protective tapes of the first electrode plate and the second electrode plate are attached by a room-temperature adhesion method. As such, the transfer of a backing agent can be suppressed, and welding quality can thereby be improved. Compared with conventional heat-compression tapes, elongation is increased and the adhesive force at room temperature is improved, which can lower the failure rate and improve manufacturing efficiency.

The low-adhesive tape used in the present disclosure has high elongation and excellent adhesive force at room temperature, showing superior performance compared to conventional heat-compression tapes. This improves the welding performance of the electrode assembly and enhances the reliability of a product.

Still further, in the present disclosure the protective tapes of the first electrode plate and the second electrode plate are configured to suppress a peak power distribution that may occur during ultrasonic tab welding, which plays an important role in improving welding quality and reducing the failure rate, especially after ultrasonic welding.

In the present disclosure, a flexible configuration is enabled by placing inner circumferential tabs and outer circumferential tabs on the inner or outer side of an electrode assembly, respectively, which thereby enables various welding methods and improves the overall manufacturing process.

These technical effects contribute to improving the quality of ultrasonic welding, enhancing the overall performance of an electrode assembly, and increasing the stability and efficiency of a battery.

Aspects of a secondary battery according to embodiments of the present disclosure will now be described.

As the positive electrode active material, a compound capable of reversibly intercalating/deintercalating lithium (e.g., a lithiated intercalation compound) may be used. For example, at least one of a composite oxide of lithium and/or a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}CO_{b}X_{c}O_{2-α}D_{α}(0.90≤a≤1.8, 0≤b≤0.5, 0≤c≤0.5, 0≤α≤2); LiₐNi_{1-b-c}Mn_{b}X_{c}O_{2-α}D_{α}(0.90≤a≤1.8, 0≤b≤0.5, 0≤c≤0.5, 0≤α≤2); LiₐNi_{b}CO_{c}L_{d}¹GeO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn2G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (AI) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x≤2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiOs, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

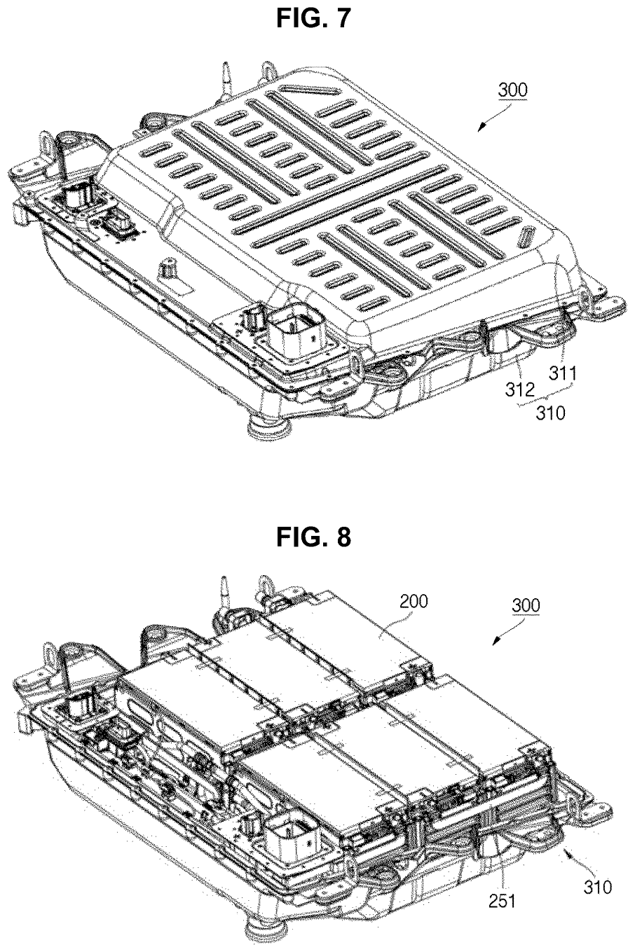

FIGS. 7 and 8 are perspective views showing a battery pack 300 including the secondary battery according to some embodiments. Referring to FIGS. 7 and 8, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the FIGS. 15 and 16, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

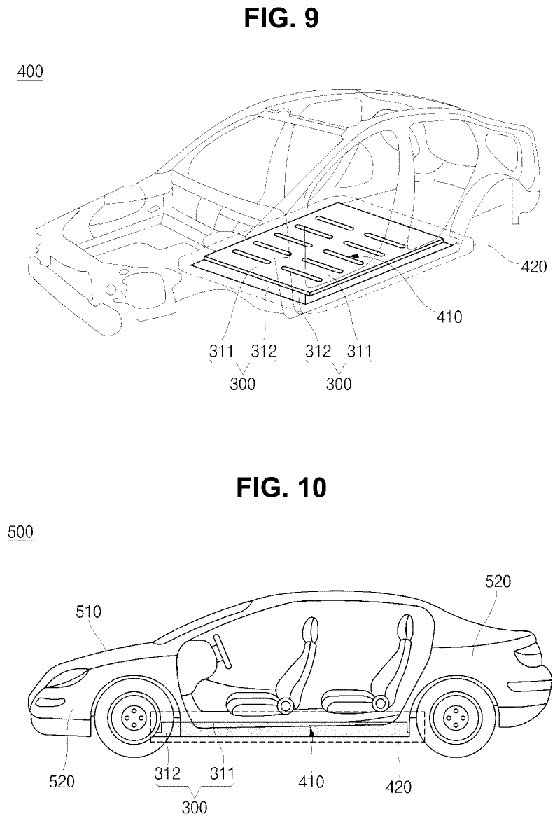

FIGS. 9 and 10 are perspective and side views showing vehicles 400 and 500 including the battery pack 300 according to some embodiments. In FIG. 9, a battery pack 300 may include a battery pack cover 311 (may correspond to the first housing above), which is a part of a vehicle underbody 410, and a pack frame 312 (may correspond to the second housing above) located under the vehicle underbody 410. The pack frame 312 and the battery pack cover 311 may be integrally formed with a vehicle floor 420. The vehicle underbody 410 separates the inside and outside of a vehicle, and the pack frame 312 may be located outside the vehicle.

In FIG. 10, a vehicle 500 may be formed by combining additional parts, such as a hood 510 in front of the vehicle and fenders 520 respectively located in the front and rear of the vehicle to a vehicle body parts 400. The vehicle 500 may further include a vehicle floor 420, which is one of the vehicle body parts 400 including the battery pack 300 including the pack frame 312 and the battery pack cover 311.

Although aspects of some embodiments of the present disclosure have been described above with limited examples and drawings, embodiments according to the present disclosure are not limited thereto, and various modifications and variations may be made by those skilled in the art in the technical field to which the present invention belongs within the technical idea of embodiments according to the present disclosure.

What is claimed is:

1. A secondary battery comprising:
an electrode assembly comprising a first electrode plate, a second electrode plate, and a separator between the first and second electrode plates, the electrode assembly being wound in a jelly-roll type structure,
wherein the first electrode plate comprises:
a conductive substrate comprising a first electrode plate-first side and a first electrode plate-second side opposite to the first electrode plate-first side;
an inner circumferential tab welded to the first electrode plate-first side;
a first electrode plate-first protective tape attached to the first electrode plate-first side while wrapping around the inner circumferential tab; and
a first electrode plate-second protective tape attached to the first electrode plate-second side and corresponding to the inner circumferential tab.

2. The secondary battery as claimed in claim 1, wherein the conductive substrate of the first electrode plate comprises:
a flat first electrode plate-first region located in a winding core region, with the first inner circumferential tab being welded to the first electrode plate-first side in the first electrode plate-first region;
a first electrode plate-bent region that is bent into a “U” shape and extends from the first electrode plate-first region; and
a flat first electrode plate-second region that extends from the first electrode plate-bent region and is opposite to the first electrode plate-first region.

3. The secondary battery as claimed in claim 2, wherein the first electrode plate-first protective tape is attached to the first electrode plate-first side in the first electrode plate-first region, the first electrode plate-bent region, and the first electrode plate-second region, and the first electrode plate-second protective tape is attached to the first electrode plate-second side in the first electrode plate-first region, the first electrode plate-bent region, and the first electrode plate-second region.

4. The secondary battery as claimed in claim 2, wherein the inner circumferential tab overlaps the first electrode plate-second protective tape in a thickness direction of the electrode assembly.

5. The secondary battery as claimed in claim 2, wherein the first electrode plate further comprises an active material layer coated on at least one of the first electrode plate-first side and the first electrode plate-second side, and
wherein uncoated portions where the active material layer is not provided are formed on the first electrode plate-first side and the first electrode plate-second side in the first electrode plate-first region, the first electrode plate-bent region, and the first electrode plate-second region.

6. The secondary battery as claimed in claim 1, wherein at least one of the first electrode plate-first protective tape and first electrode plate-second protective tapes is a room-temperature-adhesion-method low-adhesive tape comprising a backing agent, a polyethylene terephthalate layer, and an acrylate adhesive that does not include a hot-melt adhesive.

7. The secondary battery as claimed in claim 1, wherein the first electrode plate-second protective tape is a room-temperature-adhesion-method low-adhesive tape comprising a backing agent, a polyethylene terephthalate layer, and an acrylate adhesive that does not include a hot-melt adhesive.

8. The secondary battery as claimed in claim 1, wherein the first electrode plate-first protective tape is a heat-adhesion-method heat-compression tape comprising a backing agent, a polyethylene terephthalate layer, and an adhesive comprising acrylate and a hot melt adhesive, and the first electrode plate-second protective tape is a room-temperature-adhesion-method low-adhesive tape comprising a backing agent,
a polyethylene terephthalate layer, and an acrylate adhesive that does not include a hot-melt adhesive.

9. The secondary battery as claimed in claim 1, wherein at least one of the first electrode plate-first protective tape and first electrode plate-second protective tape is a room-temperature-adhesion-method low-adhesive tape from which a backing agent is not transferred in the electrode assembly.

10. The secondary battery as claimed in claim 1, wherein the first electrode plate-second protective tape is a room-temperature-adhesion-method low-adhesive tape from which a backing agent is not transferred to a portion of the first electrode plate to which the inner circumferential tab is to be welded.

11. The secondary battery as claimed in claim 1, wherein the conductive substrate is a first conductive substrate and the inner circumferential tab is a first inner circumferential tab,
wherein the second electrode plate comprises:
a second conductive substrate comprising a second electrode plate-first side and a second electrode plate-second side opposite to the second electrode plate-first side;
a second inner circumferential tab welded to the second electrode plate-second side;
a second electrode plate-first protective tape attached to the second electrode plate-second side and wrapping around the second inner circumferential tab; and
a second electrode plate-second protective tape attached to the second electrode plate-first side and corresponding to the second inner circumferential tab.

12. The secondary battery as claimed in claim 11, wherein the second conductive substrate comprises:
a flat second electrode plate-first region located in the winding core region, with the second inner circumferential tab being welded to the second electrode plate-second side in the second electrode plate-first region;
a second electrode plate-bent region that is bent into a “U” shape and extends from the second electrode plate-first region; and
a flat second electrode plate-second region that extends from second electrode plate-bent region and is opposite to the second electrode plate-first region.

13. The secondary battery as claimed in claim 12, wherein the second electrode plate-first protective tape is attached to the second electrode plate-second side in the second electrode plate-first region.

14. The secondary battery as claimed in claim 12, wherein the second inner circumferential tab overlaps the second electrode plate-second protective tape in a thickness direction of the electrode assembly.

15. The secondary battery as claimed in claim 12, wherein the second electrode plate further comprises an active material layer coated on at least one of the second electrode plate-first side and the second electrode plate-second side of the second conductive substrate, and
wherein uncoated portions where the active material layer is not provided are formed on the second electrode plate-first side and second electrode plate-second side in the second electrode plate-first region, the second electrode plate-bent region, and the second electrode plate-second region.

16. The secondary battery as claimed in claim 11, wherein at least one of the second electrode plate-first protective tape and the second electrode plate-second protective tape is a room-temperature-adhesion-method low-adhesive tape comprising a backing agent, a polyethylene terephthalate layer, and an acrylate adhesive that does not include a hot-melt adhesive.

17. The secondary battery as claimed in claim 11, wherein the second electrode plate-second protective tape is a room-temperature-adhesion-method low-adhesive tape comprising a backing agent, a polyethylene terephthalate layer, and an acrylate adhesive that does not include a hot-melt adhesive.

18. The secondary battery as claimed in claim 11, wherein the second electrode plate-first protective tape is a heat-adhesion-method heat-compression tape comprising a backing agent, a polyethylene terephthalate layer, and an adhesive comprising acrylate and a hot melt adhesive, and the second electrode plate-second protective tape is a room-temperature-adhesion-method low-adhesive tape comprising a backing agent, a polyethylene terephthalate layer, and an acrylate adhesive that does not include a hot-melt adhesive.

19. The secondary battery as claimed in claim 11, wherein at least one of the second electrode plate-first protective tape and the second electrode plate-second protective tapes is a room-temperature-adhesion-method low-adhesive tape from which a backing agent is not transferred in the electrode assembly.

20. The secondary battery as claimed in claim 11, wherein the second electrode plate-second protective tape is a room-temperature-adhesion-method low-adhesive tape from which a backing agent is not transferred to regions of the second electrode plate-second side to which the second inner circumferential tab is welded.
